(19) United States
(12) Patent Application Publication
(10) Pub. No.: US 2014/0165002 A1
(43) Pub. Date: Jun. 12, 2014

(54) METHOD AND SYSTEM USING NATURAL LANGUAGE PROCESSING FOR MULTIMODAL VOICE CONFIGURABLE INPUT MENU ELEMENTS

(71) Applicant: Kyle Wade Grove, Roseville, CA (US)

(72) Inventor: Kyle Wade Grove, Roseville, CA (US)

(21) Appl. No.: 13/709,758

(22) Filed: Dec. 10, 2012

(51) Int. Cl. G06F 3/0482

(52) U.S. Cl. CPC G06F 3/0482
USPC 715/825

(57) ABSTRACT

A method for presenting a candidate list on a user interface. The method includes processing text to obtain an entity tagged with a semantic tag and determining that the semantic tag is associated with an input menu for an application, where the input menu includes a base list including base elements. The method further includes generating a candidate list using the entity where the candidate list includes a plurality of candidate elements, where each of the candidate element is one of the base elements, where each of the candidate elements is associated with a similarity value, and where each of the similarity values exceeds a similarity threshold associated with the input menu. The method further includes presenting the candidate list to a user through the user interface associated with the application, and receiving a selection of a candidate element of the plurality of candidate elements from the user.

### BACKGROUND

Applications typically require input from users in order to perform various tasks. In many cases, the applications utilize drop down menus that include multiple elements where the user is forced to scroll through a long list of elements in order to select an appropriate element. For example, the drop down menu may list 50 states (e.g., California, Texas, etc.) and require the user to manually scroll through the list of states in order to select the appropriate state. From the perspective of the user, the aforementioned process is very inefficient. The inefficiency is further compounded when the drop down menu is presented via an application executing on a mobile device.

### SUMMARY

In general, in one aspect, the invention relates to a method for presenting a candidate list on a user interface. The method includes processing text to obtain an entity tagged with a semantic tag, wherein the text comprises a plurality of entities, wherein the entity is one of the plurality of entities, and wherein the text is derived from an utterance, determining that the semantic tag is associated with an input menu for an application, wherein the input menu comprises a base list comprising a plurality of base elements, generating a candidate list using the entity wherein the candidate list comprises a plurality of candidate elements, wherein each of the candidate element is one of the plurality of base elements, wherein each of the plurality of candidate elements is associated with a similarity value, and wherein each of the similarity values exceeds a similarity threshold associated with the input menu, presenting the candidate list to a user through the user interface associated with the application, and receiving a selection of a candidate element of the plurality of candidate elements from the user.

In general, in one aspect, the invention relates to a method for presenting candidate lists on a user interface. The method includes processing text to obtain a first entity tagged with a first semantic tag and a second entity tagged with a second semantic tag, wherein the text comprises a plurality of entities, wherein the plurality of entities comprise the first entity and the second entity, selecting a first input menu for an application, determining that the first input menu is associated with the first semantic tag, generating a first candidate list using the first entity, wherein each candidate element in the first candidate list is associated with a similarity value above a first similarity threshold, presenting the first candidate list to a user through the user interface associated with the application, receiving a selection of a first candidate element from the first candidate list, selecting a second input menu for the application, determining that the second input menu is associated with the second semantic tag, generating a second candidate list using the second entity, wherein each candidate element in the second candidate list is associated with a similarity value above a second similarity threshold, presenting the second candidate list to the user through the user interface associated with the application, receiving a selection of a second candidate element from the second candidate list, and performing, by the application, a task using the first candidate element and the second candidate element.

In general, in one aspect, the invention relates to a non-transitory computer readable medium comprising instructions, which when executed by a processor perform a method, the method includes processing text to obtain an entity tagged with a semantic tag, wherein the text comprises a plurality of entities, wherein the entity is one of the plurality of entities, and wherein the text is derived from an utterance, determining that the semantic tag is associated with an input menu for an application, wherein the input menu comprises a base list comprising a plurality of base elements, generating a candidate list using the entity wherein the candidate list comprises a plurality of candidate elements, wherein each of the candidate element is one of the plurality of base elements, wherein each of the plurality of candidate elements is associated with a similarity value, and wherein each of the similarity values exceeds a similarity threshold associated with the input menu, presenting the candidate list to a user through the user interface associated with the application, and receiving a selection of a candidate element of the plurality of candidate elements from the user.

Other aspects of the invention will be apparent from the following description and the appended claims.

### BRIEF DESCRIPTION OF DRAWINGS

FIG. 1 shows a system in accordance with one or more embodiments of the invention.

FIG. 2A shows a user device in accordance with one or more embodiments of the invention.

FIG. 2B shows a Natural Language Processing (NLP) system in accordance with one or more embodiments of the invention.

FIG. 3 shows a menu repository in accordance with one or more embodiments of the invention.

FIG. 4 shows a rules repository in accordance with one or more embodiments of the invention.

FIG. 5 shows a flowchart detailing a method for initializing the system in accordance with in accordance with one or more embodiments of the invention.

FIG. 6 shows a flowchart detailing a method semantically tagging text in accordance with in accordance with one or more embodiments of the invention.

FIG. 7 shows a flowchart detailing a method for generating a candidate list initializing the system in accordance with in accordance with one or more embodiments of the invention.

FIGS. 8A-8B show an example in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

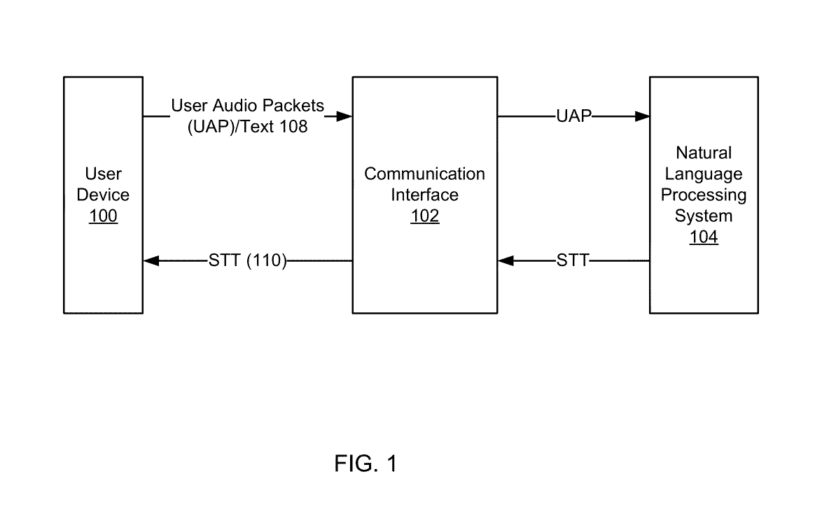

In the following description of FIGS. 1-8B, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

In general, embodiments of the invention relate to using natural language processing (NLP) to assist a user in selecting an element in an input menu. More specifically, NLP is used to identify relevant entities in an utterance and, in combination with information about what types of entities are in various input menus in an application, create a more focused list of elements from which the user may select. Said another way, NLP is used to identify a subset of elements associated with an input menu and present this subset of elements to the user (via the user interface) for selection. Further embodiments of the invention enable a user to interact with an application using both voice and non-voice input (e.g., touch, mouse click, keyboard, etc.) to select an element from an input menu.

FIG. 1 shows a system in accordance with one or more embodiments of the invention. The system includes one or more user devices (100) configured to send user audio packets (UAPs) (108) or text to the natural language processing (NLP) system (104) via a communication infrastructure (102). The NLP system (104) is configured to receive UAPs/text, process UAPs/text (108) to generate semantically tagged text (STT) (110), and to send the STT (110) to the user device (100).

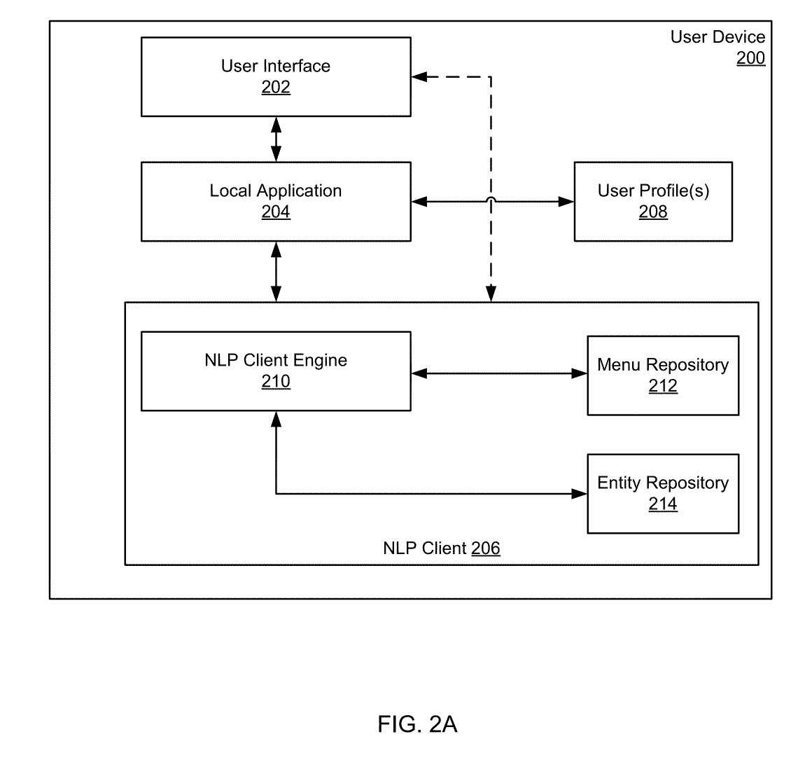

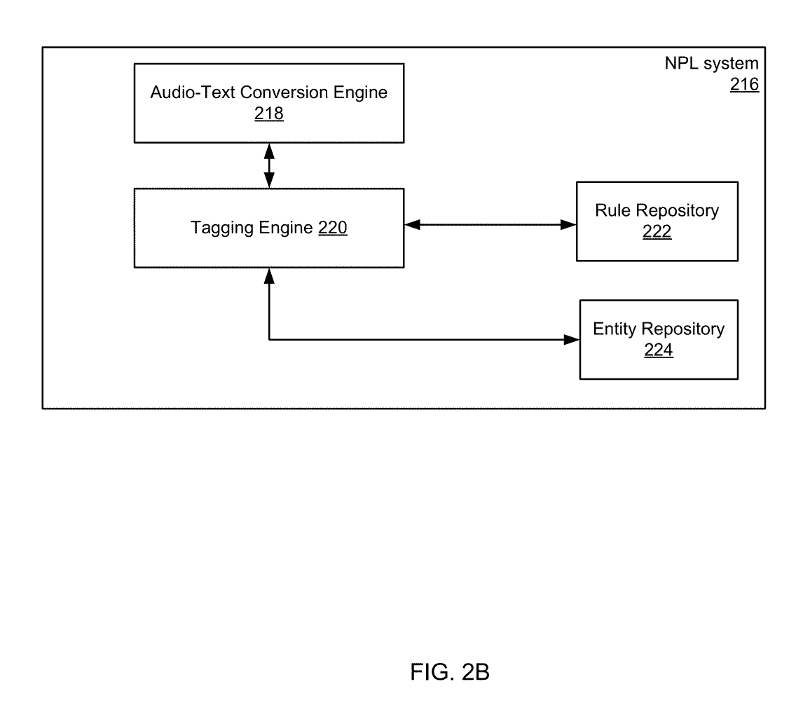

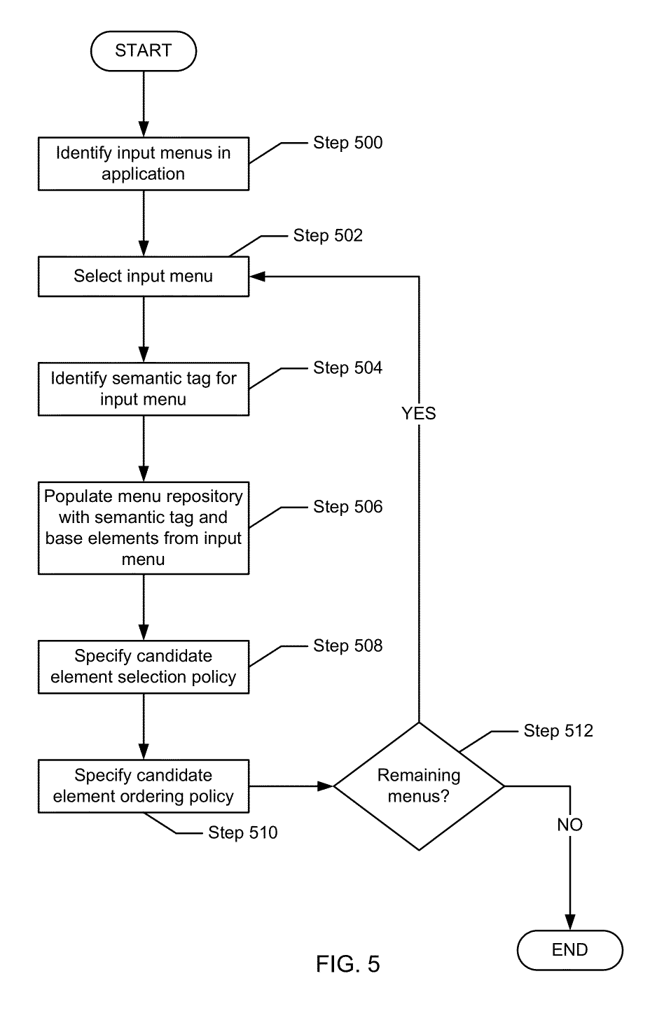

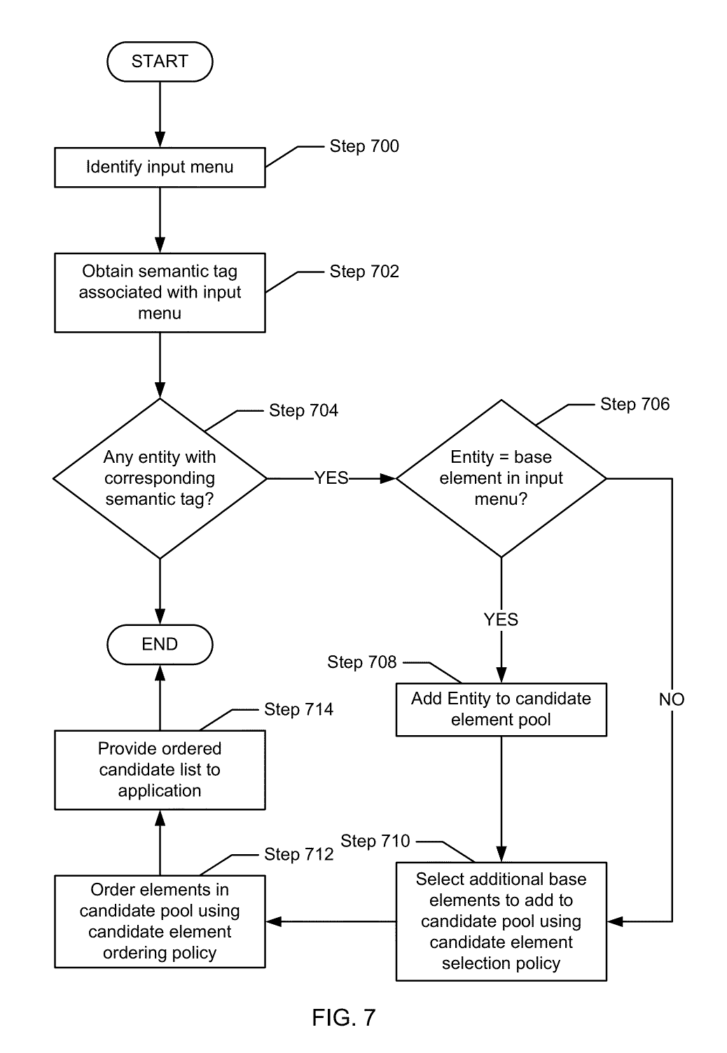

In one embodiment of the invention, the user device (100) corresponds to any physical device that includes functionality to transmit UAPs and/or text to the NLP system (104) and receive STT (110) from the NLP system. The user device (100) may further include functionality to execute one or more applications (not shown). The applications may be user-level applications and/or kernel-level applications. The applications are configured to generate UAPs/text, where UAPs/text issued by the applications are received and processed by the NLP system (104). The applications may be further configured to receive and process the STT and/or to interface with the NLP client (not shown). In some embodiments of the invention, the UAPs/text may be generated by dedicated hardware and/or the STT may be processed by dedicated hardware (as discussed below). In addition, the user device may be configured to perform the methods shown in FIGS. 5 and 7. Additional detail about user devices may be found in FIG. 2A.

In one embodiment of the invention, the physical device may be implemented on a general purpose computing device (i.e., a device with a processor(s), memory, and an operating system) such as, but not limited to, a desktop computer, a laptop computer, a gaming console, and a mobile device (e.g., a mobile phone, a smart phone, a personal digital assistant, a gaming device, etc.).

Alternatively, the physical device may be a special purpose computing device that includes an application-specific processor(s)/hardware configured to only execute embodiments of the invention. In such cases, the physical device may implement embodiments of the invention in hardware as a family of circuits and limited functionality to receive input and generate output in accordance with various embodiments of the invention. In addition, such computing devices may use a state-machine to implement various embodiments of the invention.

In another embodiment of the invention, the physical device may correspond to a computing device that includes a general purpose processor(s) and an application-specific processor(s)/hardware. In such cases, one or more portions of the invention may be implemented using the operating system and general purpose processor(s), and one or more portions of the invention may be implemented using the application-specific processor(s)/hardware.

In one embodiment of the invention, the communication infrastructure (102) corresponds to any wired network, wireless network, or combined wired and wireless network over which the user device (100) and the NLP system (104) communicate. In one embodiment of the invention, the user device (100) and NLP system (104) may communicate using any known communication protocol(s).

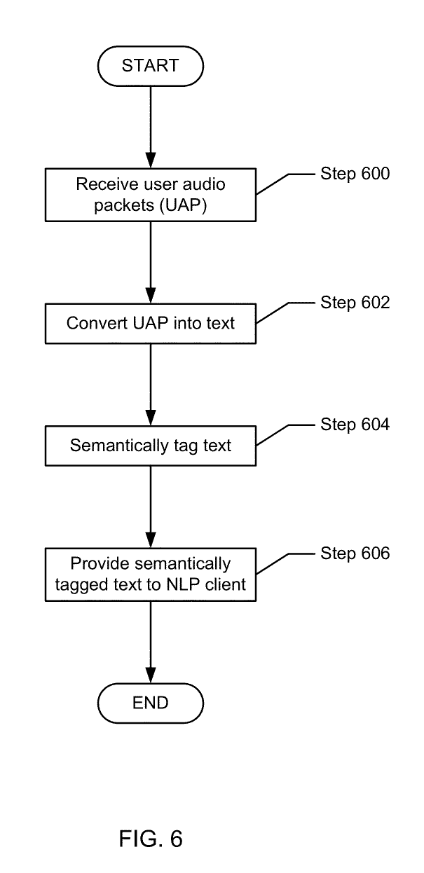

In one embodiment of the invention, the NLP system (104) corresponds to any physical device configured to process the UAPs/text in accordance with the methods shown in FIG. 6. Additional detail about the NLP system (104) is provided in FIG. 2B.

In one embodiment of the invention, the UAPs are generated by encoding an audio signal in a digital form and then converting the resulting digital audio data into one or more UAPs. The conversion of the digital audio data into one or more UAPs may include applying an audio codec to the digital audio data to compress the digital audio data prior to generating the UAPs. The use of the audio codec may enable a smaller number of UAPs to be sent to the NLP system.

In one embodiment of the invention, the audio signal may be obtained from a user speaking into a microphone on the user device. Alternatively, the audio signal may correspond to a pre-recorded audio signal that the user provided to the user device using conventional methods. In other embodiments of the invention, the user device may receive the digital audio data directly instead of receiving an analog audio signal.

In one embodiment of the invention, the audio signal includes one or more audio utterances. An audio utterance corresponds to a unit of speech bounded by silence. The utterance may be a word, a clause, a sentence, or multiple sentences. A text utterance corresponds to a unit of speech (in text form) that is provided by a user or system, where the unit of speech may be a word, a clause, a sentence, or multiple sentences. Embodiments of the invention apply to both types of utterances. Further, unless otherwise specifies, “utterance” means an audio utterance, a text utterance, or a combination thereof.

While FIG. 1 shows a system that includes a single user device, communication infrastructure, and a single NLP system, embodiments of the invention may include multiple user devices, communication infrastructures, and NLP systems without departing from the invention. Further, the invention is not limited to the system configuration shown in FIG. 1.

FIG. 2A shows a user device in accordance with one or more embodiments of the invention. The user device (200) includes a user interface (202), one or more local applications (204), a NLP client (206), and one or more user profiles (208). Each of these components is described below.

In one embodiment of the invention, the user interface (202) includes one or more physical components that include functionality to obtain input from the user and present output. With respect to input, the user interface may include functionality to obtain audio and/or text utterances from the user or from an autonomous or semi autonomous system. In addition, the input may also take the form of element selection such as, but not limited to, selecting an element in an input menu. The physical components that enable the aforementioned input mechanisms may include, but are not limited to, microphone, communication interface supporting a communication protocol (e.g., TCP/IP, Bluetooth®, etc.), a touch screen, a capacitive touch screen, a resistive touch screen, a display, a keypad, a keyboard, a virtual keypad, a virtual keyboard, a mouse, a pointer, and a touch pad. The physical components that enable the aforementioned output mechanisms may include, but are not limited to, speakers, a communication interface supporting a communication protocol (e.g., TCP/IP, Bluetooth®, etc.), a touch screen, a capacitive touch screen, a resistive touch screen, and a display. Upon receiving input, the user interface may provide the input (which may take various forms depending on how the type of input) to the appropriate local application(s) and/or the NLP client (206).

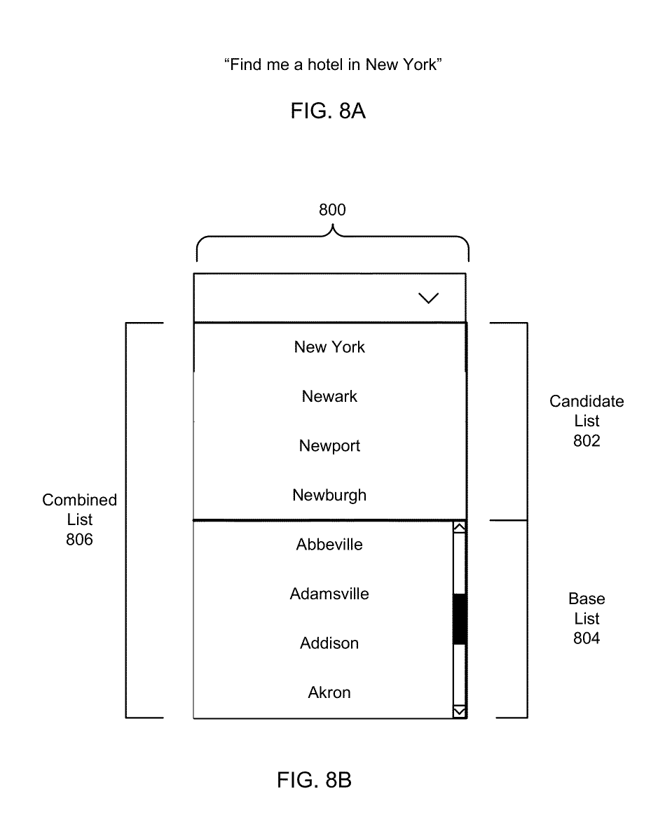

In one embodiment of the invention, local applications (204) may include kernel user-level applications and/or kernel-level applications executing on the user device. One or more local applications may be configured to interact with the NLP client (210) as discussed below. In particular, one or more local applications may be configured to use the NLP client to generate candidate lists for various input menus in the one or more local applications (see e.g., FIG. 8B). One or more local applications may also use one or more user profile(s) to facilitate the generation of one or more candidate lists. While the invention is described with respect to local applications executing on the user device, embodiments of the invention may be implemented with web-based applications that are accessed by a user of the user device via a web browser (or another local application/process).

In one embodiment of the invention, each user profile (208) includes information about a user(s) of the user device. The information may include, but is not limited to, prior utterances received from the user, various user preferences (which may be obtained directly from the user or indirectly based on prior user activity), or any other information about the user that may be used to by the local application(s) (or a web-based application) to generate one or more candidate lists.

In one embodiment of the invention, the NLP client (210) includes functionality to perform various steps described in FIGS. 5 and 7. Further, the NLP client is configured to interact with the NLP system (see FIG. 2B). In particular, the NLP client is configured to send UAPs that include the utterance or text that includes the utterance to the NLP system and to receive semantically tagged text (STT). The STT may be transmitted to the NLP client using any known communication protocol and/or mechanism.

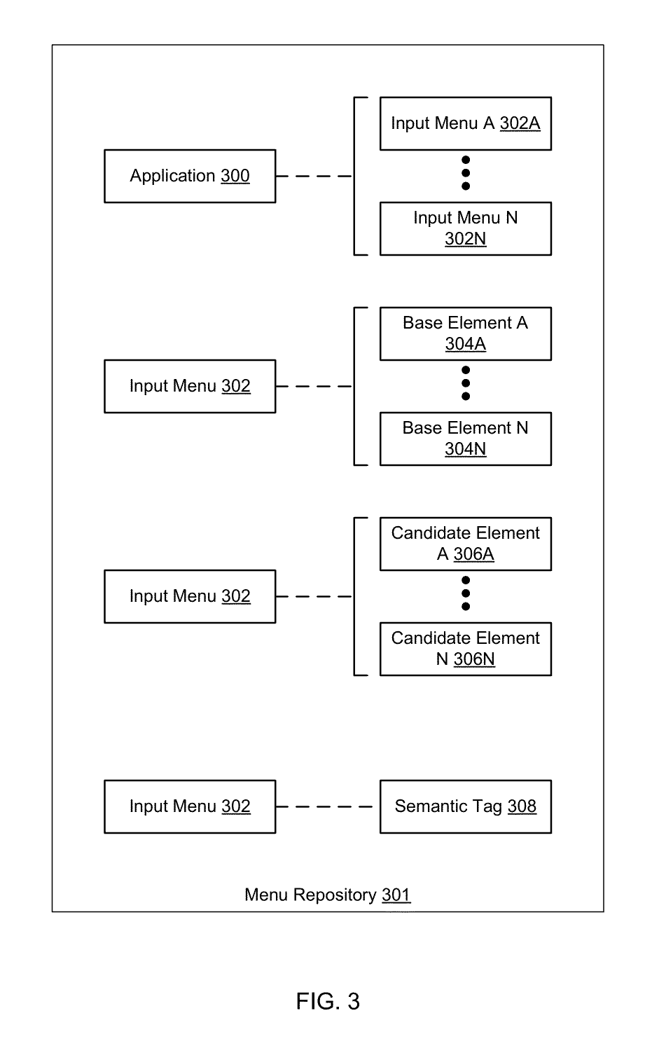

The NLP client (210) further includes a menu repository (212) configured to store information about the relationship(s) between applications and input menu, information about the relationship(s) between input menus and elements (e.g., base elements and candidate elements), and information about relationships between input menus and semantic tags. Additional detail about the menu repository is shown in FIG. 3.

The NLP client (210) further includes an entity repository (214). The entity repository (214) is configured to store the semantically tagged text (i.e., entities and the corresponding semantic tags) received from the NLP system. In one embodiment of the invention, the entity repository may only include entities that are not tagged as noise. Additional detail about the entity repository is shown in FIG. 3. In one embodiment of the invention, the entity repository (214) only includes entities that were included in utterances received by the user device (200).

The invention is not limited to the user device configuration shown in FIG. 2A.

FIG. 2B shows an NLP system in accordance with one or more embodiments of the invention. The NLP system (216) includes an audio-text conversion engine (218), a tagging engine (220), a rules repository (222), and an entity repository (224). Each of these components is described below.

In one embodiment of the invention, the audio-text conversion engine (218) is configured to receive UAPs, extract the digital audio data from the UAPs, and convert the digital audio data into text. Any known methods may be implemented by the audio-text conversion engine (202) to generate text from the digital audio data. The generated text may be viewed as a series of entities where each entity corresponds to a word or character separated by a space. For example, if the text is “Does United offer any one-flights uh, I mean one-way fares to Houston?”—then the entities would be: Does, United, offer, any one-flights, uh, I, mean, one-way, fares, to, Houston.

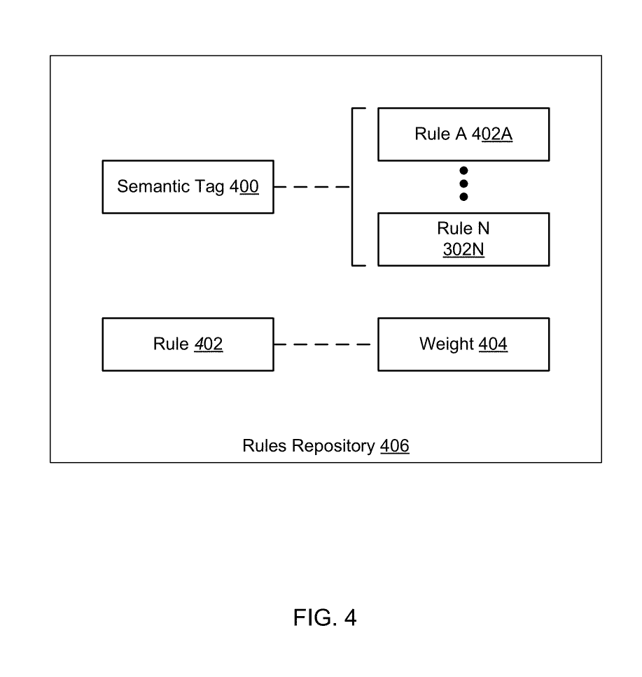

In one embodiment of the invention, the tagging engine (220) is a semantic tagger or a domain-optimized semantic tagger. The tagging engine uses the information in the rules repository (see e.g., FIG. 4) to determine how to tag each entity in the text (i.e., the text obtained from the audio-text conversion engine (202) or text obtained from the user device as part of a text utterance). Specifically, the tagging engine (204) is configured to tag, using information in the rules repository, each entity (or group of entities) as either noise or with a semantic tag (discussed below). An entity is tagged as noise if the entity does not correspond to any other semantic tag. Accordingly, whether a given entity is tagged as noise depends on the information in the rules repository. The tagging engine may use any known method for training the tagging engine to tag the entities as noise or with a semantic tag. Further, the tagging of entities may be performed using any known tagging method and/or model. For example, the tagging engine may be implemented using any known method of statistical natural language processing.

For example, in one embodiment of the invention, the tagging engine (220) uses a maximum entropy markov model to tag each entity in the text. In this embodiment the tagging engine (220) uses the information in the rules repository to determine the most likely semantic tag sequence for all entities in the utterance. Accordingly, in this embodiment, the tag for a given entity is determined not only based on the entity itself but also on the entity in relation to other entities in the utterance. Further, the tag associated with a given entity may also be determined based on application rules (discussed below).

For example, in another embodiment of the invention, the tagging engine (220) uses a maximum entropy module in combination with beam search. In this embodiment, the tagging is performed in two parts. In the first part, the maximum entropy module is used to determine a set of potential semantic tag sequences for the utterance. The number of potential semantic tag sequences in the set is determined by the size of the beam specified in the beam search parameters. In the second part, application level rules are applied to the potential semantic tag sequences to determine a semantic tag sequence with the highest probability of the being the correct semantic tag sequence. The semantic tags are associated with the entities in the utterance based on the identified semantic tag sequence.

In one embodiment of the invention, a semantic tag is used to classify an entity (or group of entities) within a domain. Said another way, the semantic tag associated with an entity provides information what the entity means in relation to the domain. For example, if the domain is hotel search then the semantic tags may be HOT, LOC-CITY, LOC-PREP, and NOI, where an entity tagged with HOT indicates that the entity is a hotel name, where an entity tagged with LOC-CITY indicates that the entity is city, where an entity tagged with LOC-PREP indicates that the entity is a spatial preposition, and where an entity tagged with NOI indicates that the entity is noise. The semantic tags are contrasted with part of speech tagging, in which the tags each identify a particular part of speech, e.g., noun, verb, etc.

In one embodiment of the invention, a semantic tag sequence for an utterance is a set of semantic tags for the utterance. For example, if the utterance is “Going to Houston, find me a Holiday Inn”, then a possible semantic tag sequence for the utterance is NOI, LOC-PREP, LOC-CITY, NOI, NOI, NOI, HOT, where there is a single semantic tag associated with the entities “Holiday Inn”.

In one embodiment of the invention, the rules repository (222) is configured to store relationships between semantic tags and rules as well as relationships between rules and weights. Additional detail about the rules repository is included in below with respect to FIG. 4.

The NLP system (216) further includes an entity repository (224). The entity repository (224) is configured to store the semantically tagged text (i.e., entities and the corresponding semantic tags) generated by the NLP system. In one embodiment of the invention, the entity repository may only include entities that are not tagged as noise. Additional detail about the entity repository is shown in FIG. 3. In one embodiment of the invention, the entity repository (214) only includes entities that were included in utterances received by one, a specific number, or all the user devices (200) that are communicating with the NLP system.

The invention is not limited to the user device configuration shown in FIG. 2B.

FIG. 3 shows a menu repository in accordance with one or more embodiments of the invention. The menu repository (301) specifies the input menus (302A, 302N) associated with each application (which may be a local application or a web-based application) (300) on the user device (i.e., the user device on which the menu repository is located) or accessible by the user device. An input menu may correspond to any field in a user interface in which an element(s) from a set of elements may be selected. One example of an input menu is a drop down menu; however, the invention is not limited to drop down menus. For each input menu (302) included in the menu repository, the menu repository includes the base elements (304A, 304N) associated with the input menu (300). Further, the menu repository includes candidate element(s) (306A, 306N) associated with each of the input menus. Finally, the menu repository specifies the semantic tag(s) (308) associated with each of the input menus.

In one embodiment of the invention, a base element is an element in the input menu that may be selected. For example, if the input menu is requesting the user to input a State as part of an address—then the input menu may include a listing of 50 states.

In one embodiment of the invention, the candidate elements are a subset of the base elements, where the candidate elements are selected by the NLP client in accordance with FIG. 7. The number of candidate elements is less than the number of base elements associated with the input menu.

FIG. 4 shows a rules repository in accordance with one or more embodiments of the invention. The rules repository (406) includes one or more semantic tags (400), where each semantic tag is associated with one or more rules (402A, 402N). Each of the rules (also referred to as feature functions) includes a Boolean function to determine whether the given rule applies to the entity being tagged (see examples below). Further, each rule (402) is associated with a given weight (404). The rules and weights are used in combination to determine the most likely semantic tag for a given entity.

In one embodiment of the invention, rules that are used to determine a semantic tag associated with a single entity in an utterance or to determine a semantic tag sequence for an utterance are collectively referred to as utterance rules.

In contrast, rules that are used to determine the most likely tag sequence based upon information other than the entities present in the utterance are referred to as application rules. Said another way, application rules take into account whether a semantic tagging sequence for a given utterance satisfies rules based on the context of the application. For example, the utterance rules may generate a tag sequence that includes two entities tagged using LOC-CITY (see example above); however, the application rules may indicate that there is a low probability that a semantic tag sequence for an utterance within the context of the application that includes two entities tagged using LOC-CITY is correct.

In one embodiment of the invention, the rules repository includes semantic tags, rules, and weights for a single domain, e.g., hotel search domain. Alternatively, the rules repository includes semantic tags, rules, and weights for multiple domains. The NLP client includes the necessary functionality to select the appropriate semantic tags, rules, and weights when tagging the text (see FIG. 6).

The various elements in the aforementioned repositories may be stored in any data structure(s) provided that such data structures maintain the relationships between the elements as described above.

FIGS. 5-7 show flowcharts in accordance with one or more embodiments of the invention. While the various steps in the flowchart are presented and described sequentially, one of ordinary skill will appreciate that some or all of the steps may be executed in different orders, may be combined or omitted, and some or all of the steps may be executed in parallel. In one embodiment of the invention, the steps shown in any of the flowcharts may be performed in parallel with the steps shown in any of the other flowcharts.

FIG. 5 shows a flowchart detailing a method for initializing the system in accordance with in accordance with one or more embodiments of the invention.

In Step 500, input menus in an application are identified. In one embodiment of the invention, the application is executing on the user device. Alternatively, the application is a web-based application that is accessible via a web browser application (e.g., Safari®, Chrome®, Internet Explorer®, etc). In Step 502, one of the input menus identified in Step 500 is selected. In Step 504, one or more semantic tags are identified for the selected input menu. For example, if the input menu lists Houston, Austin, Santa Clara, etc., then a semantic tag of LOC-CITY may be identified for the selected input menu. The identification of the one or more semantic tags for the input menu may be performed manually or by an automated process. If performed by an automated process, such a process may use heuristics (or some other mechanism) to select one or more semantic tags. In some embodiments of the invention, the base elements may be semantically tagged in accordance with the process described in FIG. 6. Based on this semantic tagging, one or more semantic tags may be identified for the input menu. In Step 506, the menu repository is populated with the semantic tag(s) identified in Step 504 and the base elements associated with the identified input menu.

In Step 508, a candidate element selection policy is specified for the input menu. In one embodiment of the invention, the candidate element selection policy specified how the candidate elements are selected from the base elements. The candidate selection policy may also specify the number of candidate elements to select and include in the candidate list. In one embodiment of the invention, the candidate selection policy may specify the number of candidate elements to select and include in the candidate list based on the size of the display on the user device. For example, the number of candidate elements for a given input menu may be set such that all elements in the candidate list may be concurrently displayed on the display of the user device. In one embodiment of the invention, the candidate selection policy specifies a similarity threshold associated with the input menu as well as one or more methods for determining the similarity value for each of the base elements associated with the input menu. The similarity threshold may be a single numeric value that quantifies the minimum amount of similarity between the base element and the entity provided in the utterance that is required for the base element to be placed on the candidate list. In one embodiment of the invention, each candidate element is associated similarity value that the greater than (exceeds) or equal to the similarity threshold.

The similar value quantifies the amount of similarity between the base element and the entity provided in the utterance. For example, if the entity is “New York” the similarity value quantifies the similarity between “New York” and base elements in the input menu—see e.g., FIG. 8B. The similarity value may be determined, example, using an edit distance algorithm (i.e., the fewer the number of edits required to make the entity identical to the base element the higher the similarity value). In another embodiment of the invention, the similarity value may be determined using a phonetic algorithm, where the level of similarity is based on how close the sound of the base element is with respect to the entity. For example, if the entity if “New York” and the base elements are “Newark” and “Atlanta”, “Newark” would have a higher similarity value than “Atlanta”. Other algorithms may be used to generate a similarity value without departing from the invention.

The candidate selection policy may also indicate that information from user profiles may be used to also identify candidate elements. For example, the user profile may indicate the last base element selected by the user for the input menu and, in such cases, this base element may also be included on the candidate list. In one embodiment of the invention, the candidate selection policy may specific the relative priority of the selected base elements, for example, based on similarity value and/or mechanism used to generate the similarity value. This priority information may be used to remove items from the candidate list if too many base elements are initially selected to be included on the candidate list.

In Step 510, the candidate element ordering policy is specified. In one embodiment of the invention, the candidate element ordering policy specifies how to present the candidate elements in the candidate list. In one embodiment of the invention, the elements may be ordered alphabetically, in descending order of similarity (based on similarity value), based upon criteria specified by the application, based upon criteria specified by the user of the user device, using another ordering scheme, or any combination thereof. In Step 512, a determination is made about whether any input menus are remaining to be processed. If there are remaining input menus to be processed, the process proceeds to Step 502; otherwise, the process ends.

In one embodiment of the invention, the candidate element selection policy and the candidate element ordering policy are stored in the menu repository and are each associated with one or more input menus specified in the menu repository.

The process shown in FIG. 5 may be performed for each application on the user device. In one embodiment of the invention, the information obtained via the process in FIG. 5 may be provided by the company/individual distributing the local application. In such embodiments, the companying/individual distributing the application may provide the information in FIG. 5 directly to the NLP client.

FIG. 6 shows a flowchart detailing a method semantically tagging text in accordance with in accordance with one or more embodiments of the invention. The process shown in FIG. 6 may be performed by the NLP system.

In Step 600, UAPs are received by the NLP system. Alternatively, the user device may send the text utterance or text obtained from converting digital audio data into text directly to the NLP system. The UAPs, text, or text utterance may be sent using any known communication protocol. In one embodiment of the invention, the NLP client or another application executing on the user device may include functionality to covert digital audio data into text. In another embodiment of the invention, the user device may send UAPs to another system (or service) that converts the digital audio data from the UAPs into text and then sends the text back to the user device. Upon receipt of the text, the user device sends the text to the NLP system.

In one embodiment of the invention, the UAP or text is received after the application (local or web-based) is started executing. In such cases, the tagging engine is configured to generate the STT based upon the context provided by the application. For example, if the application is a hotel booking application, then the tagging engine uses the appropriate rules and weights in the rule repository to generate the STT. Alternatively, the UAPs or text may be received prior to a specific application being launch, for example, the UAP or text may be received by a virtual assistant executing on the user device. In such cases, the tagging engine does not have any information about the context of UAPs or text and, as such, must determine the context based upon the content of the UAPs or text. Based on the STT generated by the tagging engine in this embodiment, the NLP system may not only provide the STT to the user device but also trigger the launch of an appropriate application on the user device based upon the STT (directly or indirectly).

Continuing with FIG. 6, in Step 602, the UAPs (or more specifically, the digital audio data within the UAPs) are converted to text by the audio-text conversion engine. This step may not be performed if the NLP system receives text or text utterances.

In Step 604, the text is semantically tagged. More specifically, each entity or group of entities is associated with a semantic tag. The semantic tags used to tag the entities are specified in the rules repository.

In Step 606, the semantically tagged text is provided to the NLP client. In one embodiment of the invention, the semantically tagged text comprises the entities and the corresponding tags. This information is stored in the entity repository upon receipt by the NLP client. The NLP client may subsequently processes the STT in accordance with FIG. 7.

In one or more embodiments of the invention, the STT may include one or more entities tagged with a semantic tag, where the semantic tags are each associated with distinct input menus that are present on distinct screens within the application.

The following section describes an example for semantic tagging in accordance with one or more embodiments of the invention. The example is not intended to limit the scope of the invention.

In this example, there are four semantic tags (see Table 1) and eight feature functions (see Table 2). Further, each combination of semantic tag and feature function (also referred to as rules) is associated with a weight (which may be positive or negative) (see Matrix 1).

TABLE 1
Semantic Tags

| Semantic Tag | Description |
|---|---|
| HOT | Hotel |
| LOC-CITY | City |
| LOC-PREP | Spatial preposition |
| NOI | Noise |

TABLE 2
Feature Functions
Feature Function

let f1 seq i = isMember (wordAt(curr(seq,i)) hotelList
let f2 seq i = contains (wordAt(curr(seq,i))
[“Inn”;“Hotel”;“Suites”;“Grand”]
let f3 seq i = isMember wordAt(prev(seq, i)) [“at”; “in”; “to”]
let f4 seq i = isMember (wordAt(curr(seq,i))) cityList
let f5 seq i = endsWith (wordAt(curr(seq,i)) [“polis”; “ville”; “ton”;
“field”]
Let f6 seq i = isMember (tagAt(prev(seq,i))) [“LOC-PREP”]
let f7 seq i = isMember (wordAt(curr(seq,i))) [“”to”; “in”; “near”;
“within”; “around”]
let f8 seq I = isUpperCase (wordAt(curr(seq,i)))

Matrix 1
Weighting Matrix

| | f1 | f2 | f3 | f4 | f5 | f6 | f7 | f8 |
|---|---|---|---|---|---|---|---|---|
| HOT | 7.2 | 2.9 | 4.6 | −3.2 | −1.6 | −3.9 | −4.2 | 8.5 |
| LOC- | −3.6 | −2.6 | −3.3 | 8.2 | 2.3 | −3.8 | −6.5 | 9.2 |
| CITY | | | | | | | | |
| LOC- | 0.0 | 0.0 | 1.0 | −2.3 | −4.0 | −6.2 | 10.2 | −4.6 |
| PREP | | | | | | | | |
| NOI | −3.0 | −3.2 | −2.4 | −9.2 | −5.6 | −2.4 | −5.3 | −9.0 |

Consider the following tagging example, using the above information, which would be stored in the rules repository. In this example, assume the utterance is “Going to Houston, find me a Holiday Inn” and that the tagging engine is trying to tag the entity “Houston”. The first step is to determine which feature functions apply. In this example, feature functions, F3, F4, F5, F6, and F8 apply. Specifically, “Houston” (i) is not in the hotelList, (ii) does not contain “Inn”, “Hotel”, “Suites” or “Grand”; (iii) is preceded by ‘in’; (iv) is in the cityList; (v) contains the suffix ‘ton’, (vi) is preceded by a LOC-PREP tagged word, (vii) is not the word ‘to’; ‘in’; ‘near’; ‘within’; ‘around’; and (viii) is capitalized.

The information related to which feature functions apply to “Houston” may be represented as a vector, e.g., X=[0; 0; 1; 1; 1; 1; 0; 1]. The weighting matrix is subsequently multiplied with the vector to obtain a weights vector that associates each semantic tag with a weight. (Weights Vector: [4.4; 12.6; −16.1; −28.6]). The weights vector is subsequently used to generate four probabilities—each one representing the probability that “Houston” should be tagged with a particular semantic tag. The generation of probabilities may be performed in accordance with known normalization methods. In this example, the resulting probabilities indicate that “Houston” should be semantically tagged with “LOC-CITY”.

FIG. 7 shows a flowchart detailing a method for generating a candidate list initializing the system in accordance with in accordance with one or more embodiments of the invention. In one embodiment of the invention, FIG. 7 is performed after the application is launched.

In Step 700, an input menu is identified. In one embodiment of the invention, identifying the input menu includes determining what input menu(s) is currently being shown on the application screen or what input menu(s) will be generated for a subsequent application screen (i.e., an application screen that has not yet been rendered on the user interface).

In Step 702, the semantic tag(s) associated with the indentified input menu is obtained from the menu repository on the user device.

In Step 704, a determination is made about whether there are any entities in the entity repository that are associated with the semantic tag identified in step 702. In one embodiment of the invention, step 704 may include searching the semantically tagged text in the entity repository to determine whether the semantic tag is present. If the semantic tag is present, the corresponding entity is obtained. If there are any entities in the entity repository that are associated with the semantic tag, the process proceeds to Step 706; otherwise the process ends.

In Step 706, a determination is made about whether the entity identified in Step 704 is a base element associated with the input menu. In one embodiment of the invention, this determination made be made using the menu repository. If the entity identified in Step 704 is a base element associated with the input menu, the process proceeds to Step 708; otherwise the process proceeds to Step 710.

In Step 708, the entity is added to the candidate pool. In Step 710, additional base elements are selected to include in the candidate pool using the candidate element selection policy associated with the input menu. In Step 712, the elements in the candidate pool are ordered using the candidate element ordering policy associated with the input menu to obtain a candidate list.

In Step 714, the candidate list is provided to the application, which subsequently presents the candidate list and the base list (i.e., the list that includes all the base elements associated with the input menu) via the user interface on the user device. In one embodiment of the invention, the base list does not include the elements that are included in the candidate list. Alternatively, the base list includes the elements that are included on the candidate list. In one embodiment of the invention, only the candidate list is provided to the application for presentation on the user interface while the base list is not presented on the user interface.

In one embodiment of the invention, the FIG. 7 may be performed in parallel for different input menus on the current application screen or on different application screens.

In response to presenting the candidate list(s), the user device may receive input from the user (or a semi autonomous or autonomous process) and, based on the input, perform a task. Further, in embodiments in which the candidate list and the base list are presented to the user device, the user (or a semi autonomous or autonomous process) may select an element from either of the lists.

FIGS. 8A-8B show an example in accordance with one or more embodiments of the invention. The example is not intended to limit the scope of the invention.

Referring to FIG. 8A, assume that the following utterance is received “Find me a hotel in New York.” Using the semantic tags, rules, and weights described above, “New York” is tagged LOC-CITY.

Referring FIG. 8B, assume that an application (not shown) includes an input menu (800) to specify a city and that the input menu is associated with the LOC-CITY semantic tag. The application may then use embodiments of the invention to generate a candidate list (802) from the base element (some of which are shown) in the base list (804). In this example, the application identifies “New York” in the entity repository as being associated with LOC-CITY. Based on this determination, the NLP client uses “New York” to generate a candidate pool. In this example, New York is added to the candidate pool as it is listed as base element for the input menu. Further, Newark, Newport, and Newburgh are added to the candidate pool based on their phonetic similarity to “New York.” Once the candidate pool is identified, the elements in the candidate pool are order in accordance with the candidate element ordering policy. In this example, the entity (“New York”) is listed first, followed by Newark, Newport, and Newburgh in decreasing order of phonetic similarity.

The combined list (806) that includes the candidate list (802) and the base list (804) is subsequently presented on the user interface. In this example, all candidate elements in the candidate list are visible while only a subset of the base elements in the base list is visible. Further, in this example, the base list is associated with a scroll bar while the candidate list is not associated with a scroll bar.

While FIG. 8B shows a visual indicator separating the candidate list the base list, embodiments of the invention may be implemented such that there is no visual demarcation between the two lists—rather, the candidate elements are presented at the beginning of the combined list and the base elements are presented after the candidate elements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for presenting a candidate list on a user interface comprising:
prior to processing text:
identifying an input menu of an application;
associating a semantic tag with the input menu; and
populating the input menu with a plurality of base elements;
processing the text to obtain an entity tagged with the semantic tag, wherein processing the text comprises providing a tagging engine with at least the entity, wherein the tagging engine applies natural language processing to at least the entity to obtain the semantic tag for the entity, wherein the semantic tag is not included in the text, wherein the text comprises a plurality of entities, wherein the entity is one of the plurality of entities, and wherein the text is derived from an utterance;
after processing the text:
determining that the semantic tag is associated with the input menu for the application;
generating a candidate list using the entity wherein the candidate list comprises a plurality of candidate elements, wherein each of the candidate element is one of the plurality of base elements, wherein each of the plurality of candidate elements is associated with a similarity value, and wherein each of the similarity values exceeds a similarity threshold associated with the input menu;
presenting the candidate list to a user through the user interface associated with the application; and
receiving a selection of a candidate element of the plurality of candidate elements from the user.

2. The method of claim 1, further comprising:
ordering the plurality of candidates in the candidate list prior to presenting the candidate list to the user.

3. The method of claim 2, wherein ordering the candidate list comprises at least one selected from a group consisting of ordering based on a user preference, ordering based on a user selection history, and ordering based on a similarity value associated with each of the plurality of candidate elements.

4. The method of claim 1, further comprising:
after processing the text:
identifying the application to execute based at least in part on the semantic tag; and
initiating execution of the application, wherein presenting the candidate list to the user through the user interface associated with the application occurs after initiating the execution of the application.

5. The method of claim 1, further comprising:
prior to receiving the text, launching the application.

6. The method of claim 1, wherein a size of the candidate list is less than the size of the base list.

7. The method of claim 1, wherein the similarity value for each of the plurality of candidate elements is generated by a determining a similarity between the candidate element and the entity.

8. The method of claim 7, wherein determining the similarity comprises determining an edit distance between the candidate element and the entity, wherein the edit distance specifies a number of text edits required to make the candidate element identical to the entity.

9. The method of claim 7, wherein determining the similarity comprises using a phonetic algorithm, wherein the phonetic algorithm specifies how close a sound of the candidate element is with respect to the entity.

10. The method of claim 1, wherein the candidate list and the base list are presented in a combined list in the user interface.

11. The method of claim 10, wherein the candidate list located above the base list in combined list.

12. The method of claim 10, wherein the base list is associated with a scroll bar in the combined list and wherein the candidate list is not associated with any scroll bar.

13. The method of claim 1, wherein tagging the entity with the semantic tag comprises using a maximum entropy markov model.

14. The method of claim 1, wherein the utterance is one selected from a group consisting of a text utterance and an audio utterance.

15. The method of claim 1, wherein the application is a web-based application.

16. A method for presenting candidate lists on a user interface comprising:
prior to processing text:
identifying a first input menu of an application;
associating a first semantic tag with the first input menu;
populating the first input menu with a first plurality of base elements;
identifying a second input menu of the application;
associating a second semantic tag with the second input menu; and
populating the second input menu with a second plurality of base elements;
processing text to obtain a first entity tagged with the first semantic tag and a second entity tagged with the second semantic tag, wherein processing the text comprises providing a tagging engine with at least the first entity and the second entity, wherein the tagging engine applies natural language processing to at least the first entity and the second to obtain the first semantic tag for the first entity and the second semantic tag for the second entity, wherein the first semantic tag is not included in the text, and wherein the second semantic tag is not included in the text, wherein the text comprises a plurality of entities, wherein the plurality of entities comprise the first entity and the second entity;
after processing the text:
selecting the first input menu for the application;
determining that the first input menu is associated with the first semantic tag;
generating a first candidate list using the first entity, wherein each candidate element in the first candidate list is associated with a similarity value above a first similarity threshold, wherein each of the candidate elements in the first candidate list is one of the first plurality of base elements;
presenting the first candidate list to a user through the user interface associated with the application;
receiving a selection of a first candidate element from the first candidate list;
selecting the second input menu for the application;
determining that the second input menu is associated with the second semantic tag;
generating a second candidate list using the second entity, wherein each candidate element in the second candidate list is associated with a similarity value above a second similarity threshold, and wherein each of the candidate elements in the second candidate list is one of the second plurality of base elements;
presenting the second candidate list to the user through the user interface associated with the application;
receiving a selection of a second candidate element from the second candidate list; and
performing, by the application, a task using the first candidate element and the second candidate element.

17. The method of claim 16, wherein processing the text comprising using a maximum entropy markov model, wherein the maximum entropy markov model comprises utterance rules and application rules.

18. The method of claim 16, wherein processing the text comprising using a maximum entropy model and beam search to obtain a set of possible semantic tag sequences for the text and applying an application rule to the set of possible semantic tag sequences to identify a semantic tag sequence comprising the first semantic tag and the second semantic tag, wherein the semantic tag sequence is in the set of possible semantic tag sequences.

19. The method of claim 16, wherein the first similarity threshold is greater than the second similarity threshold.

20. The method of claim 16, wherein a size of the first candidate list is greater than a size of the second candidate list.

21. The method of claim 16, wherein all candidate elements in the first candidate list are simultaneously visible to the user on the user interface.

22. The method of claim 16, wherein the user interface comprises a plurality of screens, wherein the plurality of screens are not displayed simultaneously, wherein the first input menu is associated with a first screen and the second input menu is associated with a second screen, wherein the plurality of screens comprise the first screen and the second screen.

23. A non-transitory computer readable medium comprising instructions, which when executed by a processor perform a method, the method comprising:
prior to processing text:
identifying an input menu of an application;
associating a semantic tag with the input menu; and
populating the input menu with a plurality of base elements;
processing text to obtain an entity tagged with semantic tag, wherein processing the text comprises providing a tagging engine with at least the entity, wherein the tagging engine applies natural language processing to at least the entity to obtain the semantic tag for the entity, wherein the semantic tag is not included in the text, wherein the text comprises a plurality of entities, wherein the entity is one of the plurality of entities, and wherein the text is derived from an utterance;
after processing the text:
determining that the semantic tag is associated with the input menu for the application;
generating a candidate list using the entity wherein the candidate list comprises a plurality of candidate elements, wherein each of the candidate element is one of the plurality of base elements, wherein each of the plurality of candidate elements is associated with a similarity value, and wherein each of the similarity values exceeds a similarity threshold associated with the input menu;
presenting the candidate list to a user through the user interface associated with the application; and
receiving a selection of a candidate element of the plurality of candidate elements from the user.
